(19) United States
(12) Patent Application Publication
(10) Pub. No.: US 2007/0028737 A1
(43) Pub. Date: Feb. 8, 2007

(54) Stripper unit for a punch retainer

(76) Inventor: David J. Moellering, Orchard Lake, MI (US)

Correspondence Address: JAMES M. DEIMEN, 320 N. MAIN STREET, SUITE 300, ANN ARBOR, MI, 48104, US

(21) Appl. No.: 11/485,863

(22) Filed: Jul. 13, 2006

Related U.S. Application Data
(60) Provisional application No. 60/706,310, filed on Aug. 8, 2005.

(51) Int. Cl. B26F 1/14

(52) U.S. Cl. 83/143; 83/690

(57) ABSTRACT

A stripper unit incorporates a precision threaded plug that preloads a mechanical die spring that, in turn, preloads the movable or traveling stripper adjacent the punch tip. The precision threaded plug simultaneously accurately locates the stripper unit on a commercially available ball-lock punch retainer. The stripper unit is entirely self-contained on the face of the ball-lock punch retainer, thus minimizing the space required on the press platen.

### BACKGROUND OF THE INVENTION

This application claims the benefit of provisional patent application Ser. No. 60/706,310, filed Aug. 8, 2005.

The field of the invention pertains to punches and dies for forming holes and depressions in metals. In particular, the invention pertains to devices and accessories for preventing work pieces from adhering to punches during high-speed, high production manufacturing.

Examples of modem punch retainers are shown in applicant's previous U.S. Pat. Nos. 5,337,835, 5,410,932 and Des. 351,395. Views of these punch retainers are also shown in FIGS. 1 and 2. Modem punches for certain applications utilize either metal or polyurethane strippers to prevent work piece drag on the punch. The metal stripper units typically extend over the sides of the punch retainers or otherwise interfere with the close placement of punch retainers. Polyurethane strippers require separate metal retainers to accurately position the strippers on the punch retainers. With a view to eliminating some of the disadvantages attendant to previous stripper units, the following more compact stripper unit has been developed.

### SUMMARY OF THE INVENTION

The new stripper unit incorporates a precision threaded plug that preloads a mechanical die spring and simultaneously locates the stripper unit on a commercially available ball-lock punch retainer. The ball-lock punch retainers are commonly used in the tool, die and metal stamping industry, and the new stripper unit is an improvement on various punch stripping units commercially available today. Use of the preloaded mechanical die spring provides for time-tested long life.

### BRIEF DESCRIPTION OF THE DRAWINGS

FIG. 1 is a top plan view of a punch retainer;

FIG. 2 is a bottom plan view of a punch retainer;

FIG. 3 is a top plan view of the new stripper unit;

FIG. 4 is a side exploded view of the new stripper unit;

FIG. 5 is a side cross-section of the new stripper unit;

FIG. 6 is a bottom plan view of the new stripper unit; and

FIG. 7 is a side view of the new stripper unit on a punch retainer.

### DESCRIPTION OF THE PREFERRED EMBODIMENT

Illustrated in FIGS. 1 and 2 are the top and bottom views of a typical commercially available ball-lock punch retainer 10. The punch retainer 10 includes bolt holes 12 for attaching the punch retainer to a press platen (not shown), threaded holes 14 with dowel locating holes at bottom, and punch retention hole 16.

In FIG. 3, the top plan view of the new stripper unit 18 illustrates the very robust stripper body 20 and the movable stripper 22. The movable stripper 22 is formed with a hole 24 shaped to match the shape of the punch (not shown).

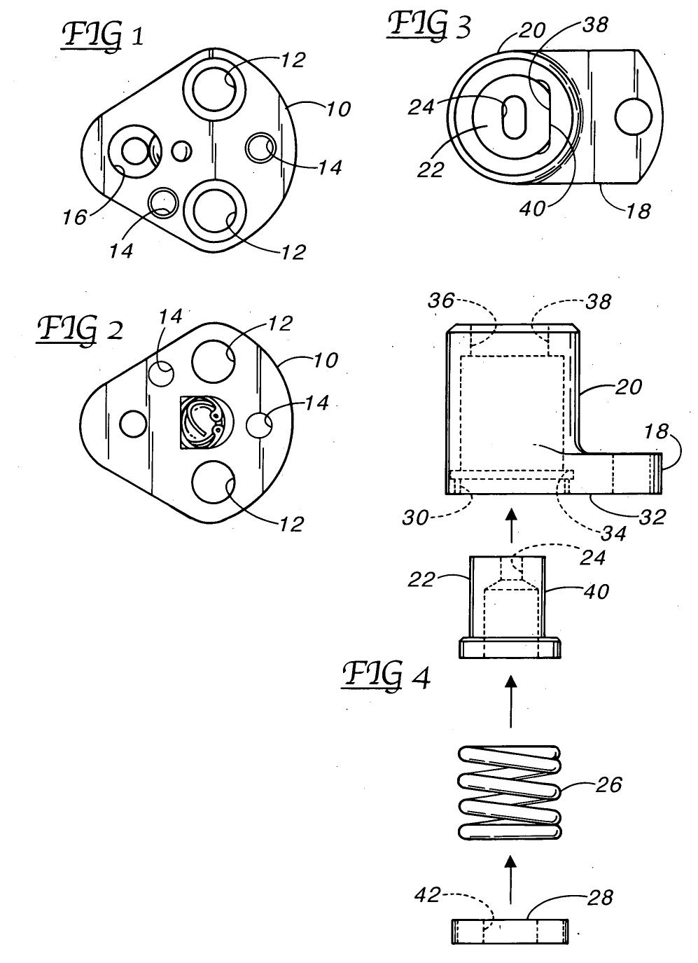

In FIG. 4, the components of the stripper unit 18 are shown in order of assembly. The stripper 22 is first inserted into the stripper body 20 followed by the mechanical die spring 26 and the precision threaded plug 28. The precision threaded plug 28 screws into a precision threaded hole 30 in the bottom 32 of the stripper body 20 and seats on an accurately machined counterbore ledge 34.

The upper bore 36 in the stripper body 20 includes a flat 38, and the stripper 22 is “D” shaped to match 40 and thereby provide assembly only in its correct position. FIG. 5 illustrates in cross-section the completely assembled stripper unit 18. As shown, the preision threaded plug 28 is tightly seated on the counterbored ledge 34.

In FIG. 6, the bottom view of the stripper unit 18 shows the precision threaded plug 28 formed with a hexagonal hole 42 therethrough. The flats 44 of the hexagonal hole 42 are sized to accurately contact the punch (not shown) and thereby accurately align the stripper unit 18 over the punch retention hole 16. Optionally, the hexagonal hole 42 may be made slightly smaller, whereby each flat 44 is formed with a slight concavity matching the curvature of the punch retention hole 16. A hex wrench can be used to tighten the precision threaded plug 28 in place.

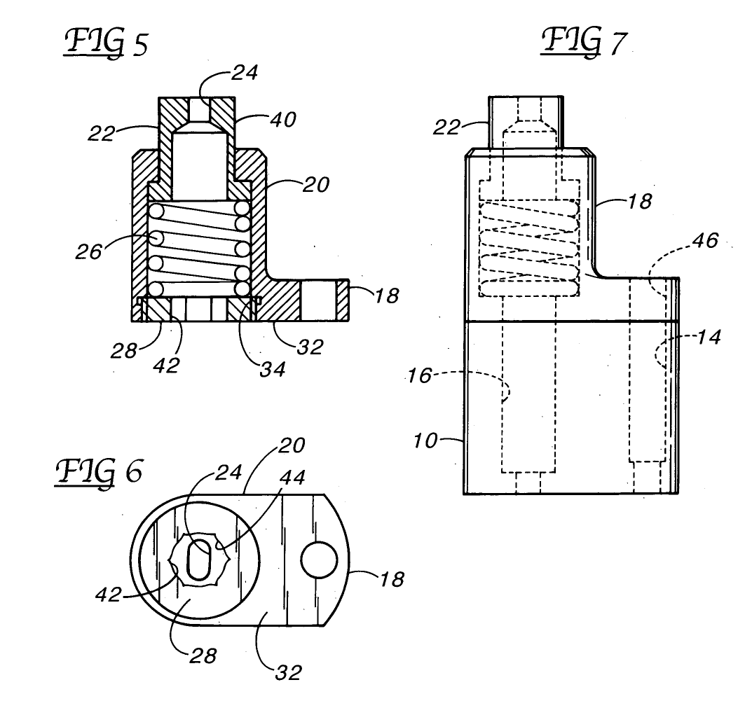

Thus, the stripper unit 18 can be perfectly aligned on the punch retainer 10, as shown in FIG. 7. A machine screw (not shown) is inserted through hole 46 in the stripper unit 18 and threaded into hole 14 of the punch retainer 10 to fasten the stripper unit to the retainer.

The construction above provides a number of improved features. The precision threaded plug 28 locates the stripper unit 18 while simultaneously pre-loading the die spring 26 for improved die spring life. Because the plug 28 has a precision machined hexagonal hole 42, the stripper unit 18 is accurately positioned and retained on its mating retainer 10. The hexagonal hole 42 provides an allen wrench hex over the precision hole to provide for easy assembly and disassembly. The new design provides that all die spring 26 and stripping forces are completely isolated in the very robust stripper body 20 with no force being transferred to any outside component. Fully assembled, the stripper unit 18 is completely “self-contained,” eliminating the risk of components being lost, or, even upon catastrophic failure, any of the units' components being jettisoned into the stamping die.

The precision threaded plug 28 is designed to bottom out in its mating pocket in the stripper body 20, which automatically sets the die spring 26 pre-load and is fail safe, so the spring cannot be overloaded.

Unlike some stripper units currently available, the new stripper unit 18 universally fits all standard ball-lock punch retainers, and most importantly requires no retainer alterations.

The movable or traveling stripper 22 is preferably of a hardened tool steel construction with a lubricating coating to promote smooth stripping movement. The stripper 22 is guided not only by the “D” body shape, but also by the stripper's head diameter or hole size and shape 24. This provides a much improved condition that will ensure the stripper 22 cannot twist or cock andjam during production and will better facilitate side load to the stripper when stripping non-flat surfaces.

The round portion of the stripper 22 and all the round features of the stripper unit 18 are co-located along the centerline of the punch and pierced hole, which simplifies design and manufacture of the stripper unit. The unique “D” shape 40 of the stripper 22 provides a failsafe assembly, allowing the stripper 22 to be assembled in the stripper body 20 only in the correct position.

The pre-loading of the die spring 26 and stripper 22 provides instant stripping force upon contact with the work piece. The instant stripping force on contact facilitates simplification of the calculations and timing questions, which are issues, especially with respect to cam activated die applications. The pre-loading also makes the overall stripper unit 18 more compact. The stripper body 20 is a one-piece construction designed with a robust heel for the attachment hole 46, making the stripper unit 18 more stable and stronger than other stripper units.

1. A stripper unit attachable to a punch retainer comprises a very robust hollow body having a threaded hole in the bottom thereof and an upper bore in the top of the hollow body,
a stripper movable in the upper bore and a die spring engaging the stripper within the hollow body,
a precision threaded plug in the threaded hole and engaging the die spring whereby the die spring and stripper are preloaded, and
means in the precision threaded plug to accurately locate the stripper unit on a punch retainer.

2. The stripper unit of claim 1, including means to prevent rotation of the stripper relative to the hollow body.

3. The stripper unit of claim 1, including means to seat the precision threaded plug and thereby set the die spring preload.

4. The stripper unit of claim 1 wherein the means in the precision threaded plug to accurately locate the stripper unit comprise a substantially hexagonal hole formed in the plug.
